(19) United States
(12) Patent Application Publication
(10) Pub. No.: US 2020/0380723 A1
(43) Pub. Date: Dec. 3, 2020

(54) ONLINE LEARNING FOR 3D POSE ESTIMATION

(71) Applicant: SEIKO EPSON CORPORATION, Tokyo (JP)

(72) Inventors: Dibyendu MUKHERJEE, Scarborough (CA); Mirza Tahir AHMED, Vaughan (CA); Ariel Shlomo KELMAN, Toronto (CA)

(73) Assignee: SEIKO EPSON CORPORATION, Tokyo (JP)

(21) Appl. No.: 16/886,183

(22) Filed: May 28, 2020

Related U.S. Application Data
(60) Provisional application No. 62/854,737, filed on May 30, 2019.

(51) Int. Cl. G06T 7/73; G06K 9/62

(52) U.S. Cl. CPC G06T 7/75; G06K 9/6256; G06T 2207/20081; G06T 2207/30244; G06T 2207/10016

(57) ABSTRACT

A non-transitory computer readable medium storing instructions to cause one or more processors to acquire, from a camera or one or more memory storing an image data sequence captured by the camera, the image data sequence containing images of an object in a scene along a time. The instructions further cause the one or more processors to track a pose of the object through an object pose tracking algorithm and during the tracking of the pose, acquire a first pose of the object in a first image of the image data sequence. The instructions further cause the one or more processor to, during the tracking, extract two-dimensional (2D) features of the object from the first image, and store a training dataset containing the extracted 2D features and the corresponding first pose in the one or more memories or other one or more memories.

### CROSS-REFERENCE TO RELATED APPLICATIONS

This disclosure claims priority to provisional application 62/854,737, filed May 30, 2019, the entire disclosure of which is hereby incorporated by reference in its entirety.

### FIELD

This disclosure relates generally to a field of pose estimation, and more specifically to methods and systems for creation of training data for use in a device in an online training arrangement.

### BACKGROUND

Three-dimensional (3D) pose estimation and six degrees of freedom (DoF) tracking have applications ranging from robotic vision and manufacturing to augmented reality. However, such training, particularly in an offline training regimen which includes training but no active object detection, has a variety of challenges. First, a large amount of training data is required with an accurate 6 DoF ground-truth, particularly when a wide view-range must be covered. Second, a training time and hardware may cause difficulty, especially when cloud-based services or high-end graphics processing units are unavailable. Third, inference time for object detection and pose estimation may be high for mobile hardware. Such challenges have been seen in, for example, template matching and feature detection based matching, especially when a wide view-range is considered.

In general template matching, where, predefined templates to match a query image to the best training sample are used, there are often challenges due to speed issues, especially when pose estimation is extended to the full view sphere. Moreover, these methods often provide a rough pose, due to the discretization of the view sphere into different templates. Some techniques use depth modality in addition to RGB, which additionally require an active sensor.

In keypoint-based techniques, descriptor-matching to match points on an image to points on a 3D model, which can then be used to align the model and get an accurate pose, are used. In these methods, keypoint descriptors such as SIFT, SURF and ORB, are learned and may be matched with points on a CAD model. Pose estimation can then be done with techniques such as perspective n-point (PnP). However, extraction and matching of descriptors is computationally quite expensive, especially with increased view-range, and the methods also reduce capability to learn all views without confusion. These methods are often unusable for online training and inference. Lastly, accurate descriptors such as SIFT, are often unsuitable for low-feature objects where unique keypoints are very hard to find.

Further, these and other types of offline training approaches are not readily applicable to many practical tasks. For example, deep networks require large amounts of training data, which is difficult to gather or generate. Further, if synthetic data is used, an additional difficulty of transferring to a domain with real images may be encountered.

Additionally, generalizing offline training results to many objects is often difficult unless a separate model is generated for each object, which has an increase complexity and computational need. Further, the complexity of these models makes it difficult to detect in real-time, particularly in situations such as for augmented reality headsets or other computationally limited applications.

In view of the limitations of offline training for object detection and pose estimation, online training for object detection and pose estimation during six DoF object tracking has been studied. Online training, also referred to as online learning, or “on-the-fly training,” for object detection after a six DoF tracking initiates, can, if effective, help lower a burden of detection from a wide-view range, and may also help increase a view range while the object is being tracked from unknown viewpoints. Re-detection from a larger view range can also be enabled. Thus, maximizing efficiency and accuracy in an online training environment for object detection and pose estimation is desirable.

While online training can provide a certain amount of relaxation because the training and inference environments are close to identical because object detection and pose estimation is invoked only during a tracking loss, online training has known difficulties. First, online training requires an extremely fast processing given that it involves actually actively detecting and tracking an object. Second, the training should support a wide view range for object detection and pose estimation and meet the challenges of fast inference. Third, particularly in mobile devices, memory consumption with online learning needs to be limited given storage capacity. Thus, training redundancy should be minimized.

### SUMMARY

An advantage of some aspects of the disclosure is to solve at least a part of the problems described above, and aspects of the disclosure can be implemented as the following aspects.

Some embodiments of the instant application serve to provide a training algorithm with improved speed, adaptability for both online and offline training, small amounts of computation and a relatively low memory requirement, and suitability for an entire 360° view range for object detection and pose estimation, and thus online learning for a complete 6-DoF pose estimation can be achieved.

Some embodiments may also allow for tracking of moving objects and, upon initial detection of the object, can eliminate the need for manual annotation of training ground truth poses for a full view sphere.

One aspect of this disclosure is a non-transitory computer readable medium storing instructions to cause one or more processors to acquire, from a camera or one or more memory storing an image data sequence captured by the camera, the image data sequence containing images of an object in a scene along a time. The instructions further cause the one or more processors to track a pose of the object through an object pose tracking algorithm and during the tracking of the pose, acquire a first pose of the object in a first image of the image data sequence. The instructions further cause the one or more processor to, during the tracking, extract two-dimensional (2D) features of the object from the first image, and store a training dataset containing the extracted 2D features and the corresponding first pose in the one or more memories or other one or more memories.

Another aspect of this disclosure is a non-transitory computer readable medium storing instruction to cause one or more processors to acquire, from a camera or one or more memories storing an image data sequence captured by the camera, the image data sequence containing images of an object in a scene along a time. The instructions further cause the one or more processor to extract 2D locations of 2D features on a first image in the image data sequence, and to derive fern values around each 2D location. The instructions further cause the one or more processor to acquire a first pose of the object in the first image with respect to the camera, and store, in the one or more memories or other one or more memories, a training dataset containing the 2D location, the fern values around the 2D location, and the corresponding pose.

Another aspect of this disclosure is a method for one or more processors to implement in a device including a camera, the one or more processors, at least one memory, and a display. The method includes acquiring, from the camera or the one or more memory storing an image data sequence captured by the camera, the image data sequence containing images of an object in a scene along a time. The method further includes extracting 2D locations of 2D features on a first image in the image data sequence. The method additionally includes deriving fern values around each 2D location, acquiring a first pose of the object in the first image with respect to the camera, and storing, in the one or more memories or other one or more memories, a training dataset containing the 2D location, the fern values around the 2D location, and the corresponding pose.

### BRIEF DESCRIPTION OF THE DRAWINGS

The disclosure will be described with reference to the accompanying drawings, wherein like numbers reference like elements.

FIG. 1 is a diagram illustrating a schematic configuration of an example head mounted display (HMD) according to an embodiment.

FIG. 2 is a block diagram illustrating a functional configuration of the HMD shown in FIG. 1 according to an embodiment.

FIG. 3 is a diagram illustrating use of the HMD shown in FIGS. 1 and 2 in a 3D real-world scene according to an embodiment.

FIG. 4 is a block diagram illustrating another functional configuration of the HMD shown in FIG. 1 according to an embodiment.

FIG. 5 is a flow diagram of an example embodiment of a method of training according to an embodiment.

FIG. 6 is a flow diagram of an example embodiment of a method of training. according to another embodiment

FIGS. 7A and 7B are a representation of exemplary ferns on a patch according to an embodiment.

FIG. 8 is a representation of extraction of fern values according to an example embodiment.

FIGS. 9A-9D show an example of results of keypoint matching according to an example embodiment.

FIG. 10A-10E show an example of images utilized for object detection according to an example embodiment.

FIG. 11 shows a diagram of training view coverage according to an example embodiment.

### DETAILED DESCRIPTION OF EMBODIMENTS

The methods and instructions described herein may be implemented on any suitable device or system that includes a camera and a display. Such suitable devices may include, for example, a mobile phone, a tablet computer, a desktop computer (with a camera), a smart watch, a digital camera, an extended reality (XR) headset (e.g., a transparent HMD), or the like. All such suitable devices may be referred to generally as an XR device. Embodiments of the instant disclosure will be described with reference to an HMD, but as noted above the methods may be implemented, with appropriate modification, on any suitable device or system that includes a camera and a display. Moreover, examples will be described herein with reference to augmented reality (AR), but the methods may be implemented, with appropriate modification, in virtual reality (VR), mixed reality (MR), or any other XR system.

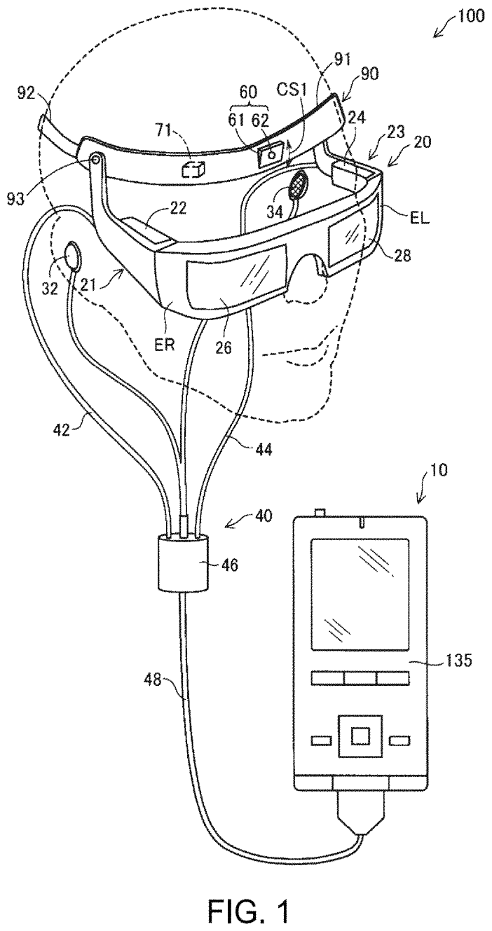

FIG. 1 shows a schematic configuration of an HMD 100. The HMD 100 is a head-mounted display device (a head mounted display). The HMD 100 is an optical transmission type. That is, the HMD 100 can cause a user to sense a virtual image and, at the same time, cause the user to directly visually recognize an outside scene.

The HMD 100 includes a wearing belt 90 wearable on the head of the user, a display section 20 that displays an image, and a control section 10 that controls the display section 20. The display section 20 causes the user to sense a virtual image in a state in which the display section 20 is worn on the head of the user. The display section 20 causing the user to sense the virtual image is referred to as “display AR” as well. The virtual image sensed by the user is referred to as AR image as well.

The wearing belt 90 includes a wearing base section 91 made of resin, a belt 92 made of cloth coupled to the wearing base section 91, a camera 60, and an IMU (Inertial Measurement Unit) 71. The wearing base section 91 has a shape curved along the form of the frontal region of a person. The belt 92 is worn around the head of the user.

The camera 60 functions as an imager. The camera 60 is capable of imaging an outside scene and disposed in a center portion of the wearing base section 91. In other words, the camera 60 is disposed in a position corresponding to the center of the forehead of the user in a state in which the wearing belt 90 is worn on the head of the user. Therefore, the camera 60 images an outside scene, which is a real scene on the outside in a line of sight direction of the user, and acquires a captured image, which is an image captured by the camera 60, in the state in which the user wears the wearing belt 90 on the head.

The camera 60 includes a camera base 61 that rotates with respect to the wearing base section 91 and a lens 62, a relative position of which is fixed with respect to the camera base 61. The camera base 61 is disposed to be capable of rotating along an arrow CS1, which indicates a predetermined range of an axis included in a plane including the center axis of the user, when the wearing belt 90 is worn on the head of the user. Therefore, the direction of the optical axis of the lens 62, which is the optical axis of the camera 60, can be changed in the range of the arrow CS1. The lens 62 images a range that changes according to zooming centering on the optical axis.

The IMU 71 is an inertial sensor that detects acceleration. The IMU 71 can detect angular velocity and terrestrial magnetism in addition to the acceleration. The IMU 71 is incorporated in the wearing base section 91. Therefore, the IMU 71 detects acceleration, angular velocity, and terrestrial magnetism of the wearing belt 90 and the camera base section 61.

A relative position of the IMU 71 to the wearing base section 91 is fixed. Therefore, the camera 60 is movable with respect to the IMU 71. Further, a relative position of the display section 20 to the wearing base section 91 is fixed. Therefore, a relative position of the camera 60 to the display section 20 is movable. In some other embodiments, the camera 60 and IMU 71 may be provided in the display section 20, so that they are fixed with respect to the display section 20. The spatial relationships represented by the rotation and translation matrices among the camera 60, IMU 70 and display section 20, which have been obtained by calibration, are stored in a memory area or device in the control section 10.

The display section 20 is coupled to the wearing base section 91 of the wearing belt 90. The display section 20 is an eyeglass type. The display section 20 includes a right holder 21, a right display driver 22, a left holder 23, a left display driver 24, a right optical-image display 26, and a left optical-image display 28.

The right optical-image display 26 and the left optical-image display 28 are located in front of the right eye and the left eye of the user when the user wears the display section 20. One end of the right optical-image display 26 and one end of the left optical-image display 28 are connected to each other in a position corresponding to the middle of the forehead of the user when the user wears the display section 20.

The right holder 21 has a shape extending in a substantial horizontal direction from an end portion ER, which is the other end of the right optical-image display 26, and inclining obliquely upward halfway. The right holder 21 connects the end portion ER and a coupling section 93 on the right side of the wearing base section 91.

Similarly, the left holder 23 has a shape extending in a substantial horizontal direction from an end portion EL, which is the other end of the left optical-image display 28 and inclining obliquely upward halfway. The left holder 23 connects the end portion EL and a coupling section (not shown in the figure) on the left side of the wearing base section 91.

The right holder 21 and the left holder 23 are coupled to the wearing base section 91 by left and right coupling sections 93 to locate the right optical-image display 26 and the left optical-image display 28 in front of the eyes of the user. Note that the coupling sections 93 couple the right holder 21 and the left holder 23 to be capable of rotating and capable of being fixed in any rotating positions. As a result, the display section 20 is provided to be capable of rotating with respect to the wearing base section 91.

The right holder 21 is a member provided to extend from the end portion ER, which is the other end of the right optical-image display 26, to a position corresponding to the temporal region of the user when the user wears the display section 20.

Similarly, the left holder 23 is a member provided to extend from the end portion EL, which is the other end of the left optical-image display 28 to a position corresponding to the temporal region of the user when the user wears the display section 20. The right display driver 22 and the left display driver 24 are disposed on a side opposed to the head of the user when the user wears the display section 20.

The display drivers 22 and 24 include liquid crystal displays 241 and 242 (hereinafter referred to as “LCDs 241 and 242” as well) and projection optical systems 251 and 252 explained below. The configuration of the display drivers 22 and 24 is explained in detail below.

The optical-image displays 26 and 28 include light guide plates 261 and 262 and dimming plates explained below. The light guide plates 261 and 262 are formed of a light transmissive resin material or the like and guide image lights output from the display drivers 22 and 24 to the eyes of the user.

The dimming plates are thin plate-like optical elements and are disposed to cover the front side of the display section 20 on the opposite side of the side of the eyes of the user. By adjusting the light transmittance of the dimming plates, it is possible to adjust an external light amount entering the eyes of the user and adjust visibility of a virtual image.

The display section 20 further includes a connecting section 40 for connecting the display section 20 to the control section 10. The connecting section 40 includes a main body cord 48 connected to the control section 10, a right cord 42, a left cord 44, and a coupling member 46.

The right cord 42 and the left cord 44 are two cords branching from the main body cord 48. The display section 20 and the control section 10 execute transmission of various signals via the connecting section 40. As the right cord 42, the left cord 44, and the main body cord 48, for example, a metal cable or an optical fiber can be adopted.

The control section 10 is a device for controlling the HMD 100. The control section 10 includes an operation section 135 including an electrostatic track pad and a plurality of buttons that can be pressed. The operation section 135 is disposed on the surface of the control section 10.

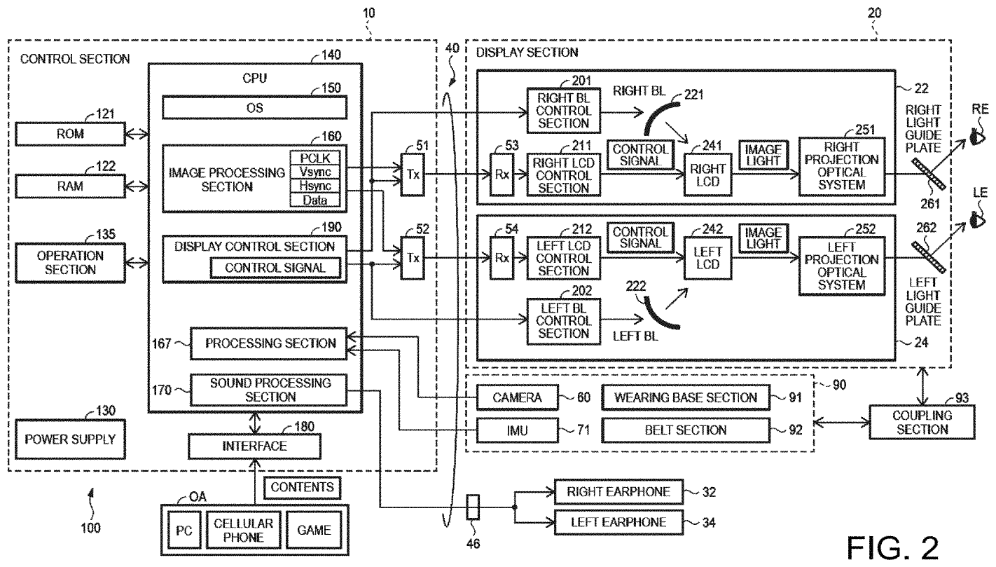

FIG. 2 is a block diagram functionally showing the configuration of the HMD 100. As shown in FIG. 2, the control section 10 includes a ROM 121, a RAM 122, a power supply 130, the operation section 135, a CPU 140 (sometimes also referred to herein as processor 140), an interface 180, and a transmitter 51 (Tx 51) and a transmitter 52 (Tx 52).

The power supply 130 supplies electric power to the sections of the HMD 100. Various computer programs are stored in the ROM 121. The CPU 140 develops, in the RAM 122, the computer programs stored in the ROM 121 to execute the computer programs. The computer programs include computer programs for realizing tracking processing and AR display processing explained below.

The CPU 140 develops or loads, in the RAM 122, the computer programs stored in the ROM 121 to function as an operating system 150 (OS 150), a display control section 190, a sound processing section 170, an image processing section 160, and a processing section 167.

The display control section 190 generates control signals for controlling the right display driver 22 and the left display driver 24. The display control section 190 controls generation and emission of image lights respectively by the right display driver 22 and the left display driver 24.

The display control section 190 transmits control signals to a right LCD control section 211 and a left LCD control section 212 respectively via the transmitters 51 and 52. The display control section 190 transmits control signals respectively to a right backlight control section 201 and a left backlight control section 202.

The image processing section 160 acquires an image signal included in contents and transmits the acquired image signal to receivers 53 and 54 of the display section 20 via the transmitters 51 and 52. The sound processing section 170 acquires a sound signal included in the contents, amplifies the acquired sound signal, and supplies the sound signal to a speaker (not shown in the figure) in a right earphone 32 and a speaker (not shown in the figure) in a left earphone 34 connected to the coupling member 46.

The processing section 167 acquires a captured image from the camera 60 in association with time. The time in this embodiment may or may not be based on a standard time. The processing section 167 calculates a pose of an object (a real object) according to, for example, a homography matrix. The pose of the object means a spatial relation (a rotational relation) between the camera 60 and the object. The processing section 167 calculates, using the calculated spatial relation and detection values of acceleration and the like detected by the IMU 71, a rotation matrix for converting a coordinate system fixed to the camera 60 to a coordinate system fixed to the IMU 71. The function of the processing section 167 is used for the tracking processing and the AR display processing explained below.

The interface 180 is an input/output interface for connecting various external devices OA, which are supply sources of contents, to the control section 10. Examples of the external devices OA include a storage device having stored therein an AR scenario, a personal computer (Pc), a cellular phone terminal, and a game terminal. As the interface 180, for example, a USB interface, a micro USB interface, and an interface for a memory card can be used.

The display section 20 includes the right display driver 22, the left display driver 24, the right light guide plate 261 functioning as the right optical-image display 26, and the left light guide plate 262 functioning as the left optical-image display 28. The right and left light guide plates 261 and 262 are optical see-through elements that transmit light from real scene.

The right display driver 22 includes the receiver 53 (Rx53), the right backlight control section 201 and a right backlight 221, the right LCD control section 211 and the right LCD 241, and the right projection optical system 251. The right backlight control section 201 and the right backlight 221 function as a light source.

The right LCD control section 211 and the right LCD 241 function as a display element. The display elements and the optical see-through elements described above allow the user to visually perceive an AR image that is displayed by the display elements to be superimposed on the real scene. Note that, in other embodiments, instead of the configuration explained above, the right display driver 22 may include a self-emitting display element such as an organic EL display element or may include a scan-type display element that scans a light beam from a laser diode on a retina. The same applies to the left display driver 24.

The receiver 53 functions as a receiver for serial transmission between the control section 10 and the display section 20. The right backlight control section 201 drives the right backlight 221 on the basis of an input control signal. The right backlight 221 is a light emitting body such as an LED or an electroluminescence (EL) element. The right LCD control section 211 drives the right LCD 241 on the basis of control signals transmitted from the image processing section 160 and the display control section 190. The right LCD 241 is a transmission-type liquid crystal panel on which a plurality of pixels is arranged in a matrix shape.

The right projection optical system 251 is configured by a collimate lens that converts image light emitted from the right LCD 241 into light beams in a parallel state. The right light guide plate 261 functioning as the right optical-image display 26 guides the image light output from the right projection optical system 251 to the right eye RE of the user while reflecting the image light along a predetermined optical path. Note that the left display driver 24 has a configuration same as the configuration of the right display driver 22 and corresponds to the left eye LE of the user. Therefore, explanation of the left display driver 24 is omitted.

The device to which the technology disclosed as an embodiment is applied may be an imaging device other than an HMD. For example, the device may be an imaging device that has no function of displaying an image. In other embodiments, the technology disclosed as an embodiment may be applied to any suitable device including a camera and a display, such as a mobile phone, a tablet computer, and the like.

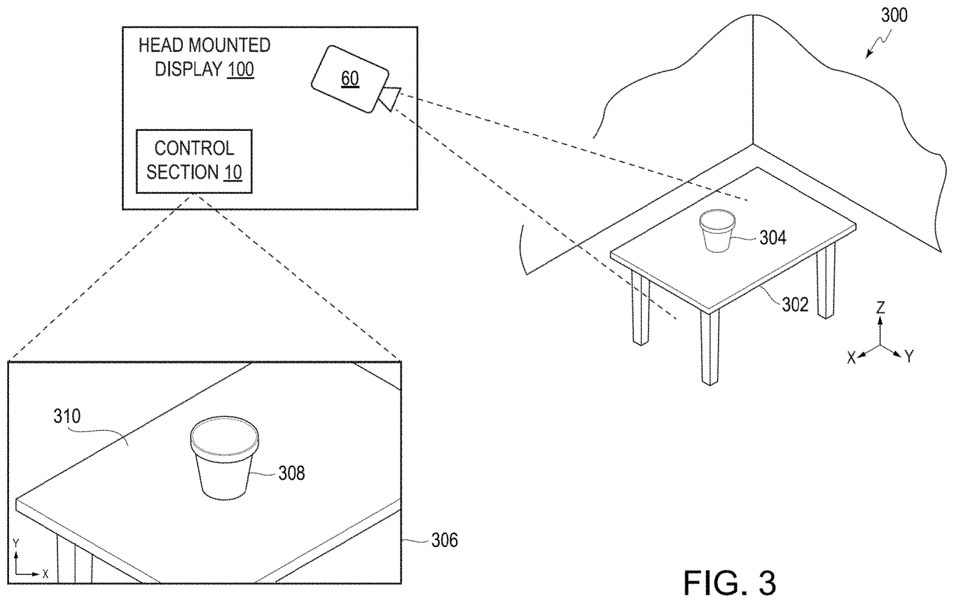

FIG. 3 is a diagram illustrating use of the HMD 100 in a three dimensional (3D) real-world scene 300. Scene 300 includes a table 302 and an object 304 on the table 302. A user (not shown) wearing HMD 100 is positioned to view the scene 300. The camera 60 of the HMD 100 also views the scene 300 from approximately the same viewpoint as the user. In some embodiments a calibration is performed to align the 3D coordinate system of the camera 60 with the 3D coordinate system of the user in order to attempt to minimize any difference between the viewpoint of the camera and the viewpoint of the user. The camera 60 captures images of the scene 300 from the viewpoint and provides an image data stream to the control section 10. The image data stream includes multiple temporally separate two dimensional (2D) image frames. FIG. 3 includes an example image frame 306, sometimes referred to as an image, received by the control section 10. The image frame 306 includes a representation 308 of the object 304 as viewed from the camera's viewpoint and a representation 310 of a portion of the table 302. A representation of an object, such as the representation 308 of object 304, in an image frame is sometimes also referred to herein as the object in the image frame.

As will be explained in more detail herein, the control section 10 attempts to locate the representation 310 of the object 304 in the image frame 306 and determine its pose. The control section 10 then attempts to track the representation 310 of the object 304 and update the pose of the object through subsequent image frames.

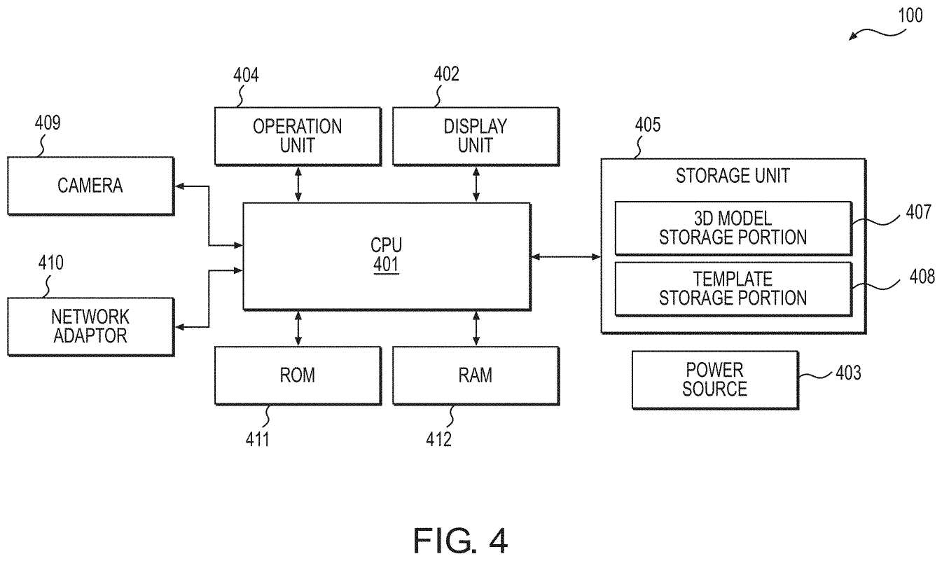

Additionally or alternatively, FIG. 4 shows exemplary hardware that may further carry out embodiments. HMD 100 may include a central processor (CPU 401), which is operably connected to a display unit 402 and an on operation unit 404. The operation unit 4 may be any user interface that is capable of receiving an operation from a user, such as a keyboard, mouse, or touch pad and the corresponding software to operate such hardware.

Also operably connected to the CPU 401 is a camera 409, which may carry out the same or similar functions as camera 60 in FIG. 1. The camera 409 may include an RGB image sensor or an RGBD sensor and can be used upon acquisition of an image by the CPU 401. The system may further include a network adaptor 410 operably connected to CPU 1, as well as memory components in the form of ROM 411 and RAM 412. The network adaptor 10 may be configured to allow the CPU 401 to communicate with other computers, such as server computers, via a wireless network. The HMD 100 may thus receive from other computer(s) a program that causes the HMD 100 to perform functions as described in further detail herein.

The CPU 401 may be further operably connected to a storage unit 405, which may include additional memory components and may have its own ROM and RAM components. Included in the storage unit 405 may be a 3D model storage portion 407 and a template storage portion 408. The storage unit 405 may be provided to store various items of data and computer programs, including machine learning algorithm models as further described herein. Such models may or may not include their learned or trained parameters. The storage unit may also include a hard disk drive, a solid-state drive and the like. The 3D model storage portion 407 may be embodied to store a three-dimensional model of a target object, which may be created using computer-aided design (CAD) or manual design. The template storage portion 408 stores a template created by a template creator.

Further, a power source 403 may exist to power the CPU and other components of the HMD. The power source 403 may be a battery such as a secondary battery or any source that may provide electric or mechanical energy.

The CPU 401 may read various programs from the ROM 411 and load the programs into the RAM 412, so as to execute the various programs.

While reference is made to the hardware structure of FIG. 1 herein with respect to the embodiments discussed later, the hardware structure of FIG. 4 described is also fully capable of carrying out all embodiments of the instant application.

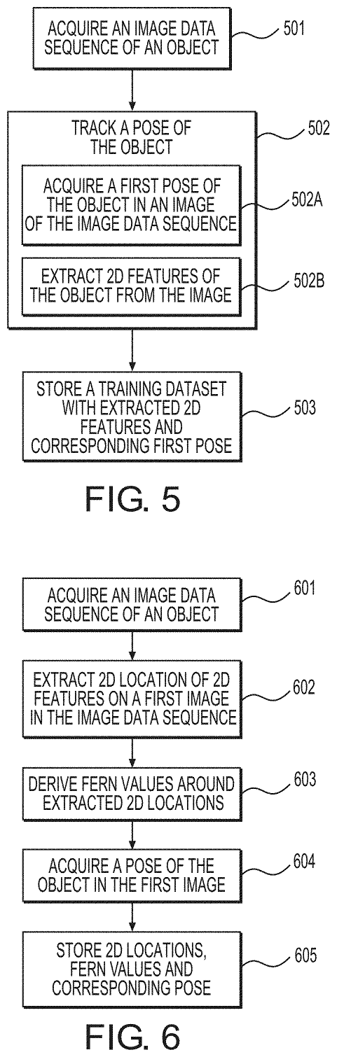

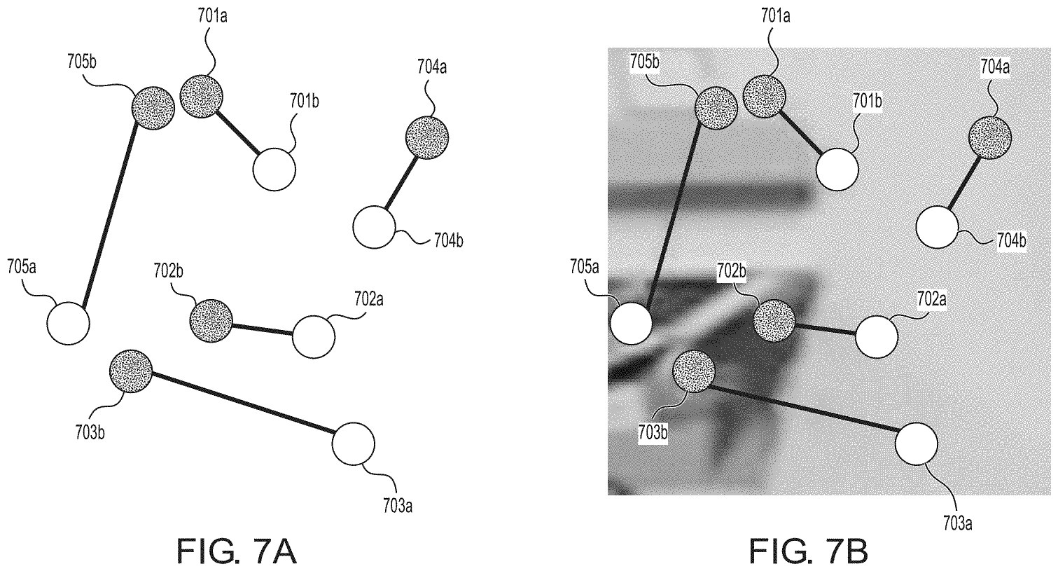

FIGS. 5 and 6 are flow diagrams of example embodiments of method of training according to embodiments. FIG. 5 shows the following steps: step 501 acquire an image data sequence; step 502 track a pose of the object; step 502A acquire a first pose; step 502B extract 2D features; and step 503 store a training dataset.

With reference to FIG. 5, the relationship of performing extraction during pose tracking is shown. In some embodiments, an image data sequence is acquired in step 501 in FIG. 5. Further details of image and pose acquisition is described with reference to FIG. 6 and step 601 below.

At some time after the acquisition of the image data sequence, either before, in conjunction with or after 2D feature extraction as described in further detail below and shown in step 502B, a first pose of the object may be acquired. This step is shown as step 502A in FIG. 5, whereby the first pose of the object is acquired in an image of the image data sequence. In some embodiments, the acquisition of the first pose of the object and the extraction of the 2D features of the object from the image occurs during the tracking of the pose, e.g., in an online learning environment (shown as step 502).

It is noted that the step of tracking a pose of the object (step 502) illustrated in FIG. 5 to be covering steps 502A and 502B which is intended to mean that steps 502A and 502B are done while step 502 is being performed.

Upon acquisition of the image data sequence, and either before or after acquisition of the pose of the object with respect to the camera, a feature extraction step may occur. As shown in FIG. 5, a step of extracting 2D features of the object from the first image may occur. This may occur, as shown in FIG. 5, during the tracking of the pose (e.g., in an online learning environment) as in step 502B. However, the extraction of the 2D features may also be performed before or after or concurrent with the acquiring the pose of the object in the image. Exemplary feature extraction is described with reference to FIG. 6, below.

Once the features are extracted in a manner such as the manner with reference to FIG. 6 below, a training dataset including such features is placed, or stored, into a memory along with a corresponding first pose, as shown in step 503 of FIG. 5. This may be used for faster keypoint matching.

FIG. 6 includes some steps similar to FIG. 5 as explained below, and is further described herein. Additionally, the steps of FIG. 5 may include or correspond to all, or some of, the steps described with reference to FIG. 6, as described in more detail below.

Image and Pose Acquisition

FIG. 6 shows the following steps (each of which are discussed herein in depth): step 601 acquiring an image data sequence (as mentioned above); step 602 of extraction of 2D locations of 2D features on the first image; step 603 of fern value derivation; and in step 604, an acquisition of the pose (also referred to herein as a first pose) of the object in a first image in an image data sequence with respect to the camera 9.

FIG. 6 highlights the use of fern values. It is also noted that in FIG. 5 the first pose may be acquired prior to 2D feature extraction whereas in FIG. 6 the first pose may be acquired after 2D feature extraction.

In some embodiments, an image data sequence is acquired in step 601 in FIG. 6. This sequence acquisition is similar to step 501 in FIG. 5, but is repeated herein to further explain the image and pose acquisition. The image data sequence may represent any sequence of data that is acquired from a camera, such as camera 60 described above, or from one or more memories that store an image data sequence that is captured by such camera 60 or camera 9. The memory may be in the form of a read-only memory (ROM) such as ROM 121, a random access memory such as RAM 122, or any other memory device of HMD 100 or another imaging device.

The camera 60 may be programmed to be used when the central processor (such as CPU 140) of the HMD 100 acquires an image. The image may include a 2.5D (two and a half dimensional or depth map) image or a video/2.5D video sequence of a real object. This may occur in conjunction with the processing section 167, whereby external scenery including a target object is detected. Interest points, for example particular points of the object or edges of the object or the like, may be determined and acquired by the processing section 167.

Subsequent to or in conjunction with the acquisition of the image data sequence, a pose of the object is tracked through an object pose tracking algorithm. In some embodiments, the pose is tracked in conjunction with the acquisition of the image data sequence, during a real-time online learning environment.

Exemplary image tracking may include tracking a pose through an object pose tracking algorithm, though it may also be acquired through other available means. Such an object pose tracking algorithm may require a user to move around a real-world object once the tracking has been lost until her view of the object is similar to the view at which one of the poses was captured to create the original training data, so that the tracking can be initiated through a first pose estimation using the trained pose. Original training data based on one or a few poses of the object may be based on synthetic image(s) of a 3D model (such as a CAD model) rendered from a predetermined view(s) and/or a camera image(s) of a reference real object captured from the predetermined view(s), where the 3D model and the reference real object correspond to the real object. Additionally, or alternatively, the original training data may be based on only the shape of the object, without any data about surface features, such as color, texture, surface images/text, etc. The CPU 140 of the HMD 100 may track a pose of the real object with respect to the camera.

In FIG. 6, the acquisition of the pose (step 604) may occur subsequent to the extraction of 2D locations of 2D features on the first image (step 602) and subsequent to fern value derivation (step 603), both discussed in further detail below. However, the pose acquisition need not be subsequent to such steps and may be prior to any extraction, including extraction of such 2D locations of 2D features on the first image, and before or after any derivation of fern values. Further, the acquisition of the first pose may be in during the tracking of the pose, (e.g., in an online learning environment).

Feature Extraction

As shown in FIG. 6, a step of extracting 2D locations on a first image in the image data sequence may occur in step 602. An exemplary extraction is described now, though extraction of keypoints or 2D features of the object is not limited thereto. In some examples, about 300-500 or about 400 keypoints are acquired from the image. However, this amount is not limited and may be adjusted as necessary based upon the size of the image, necessary data acquisition requirements, memory capacity and the like.

Similar to the extraction in step 502B of FIG. 5, the extraction in step 602 of FIG. 6 may be performed by a suitable method. The online learning algorithm may then incorporate the extracted feature data into the original training data to create updated training data. For example, maxima and minima features through an image gradient can be used to acquire the keypoints. In some embodiments, the updated training data replaces the original training data in a training data storage portion, which may correspond to, for example, the template storage portion 408 or a 3D model storage potion 407 in FIG. 4. In other embodiments, both sets of training data are kept. In some embodiments, the computer outputs the updated training data to the HMD 100, either in addition to storing it in the training data storage portion or instead of storing it in the training data storage portion. The HMD 100 may then use the updated training data to replace the original training data.

Fern Value Background

FIG. 6 shows a step 603 of deriving fern values around each extracted 2D location. A description of fern values, particularly random ferns and binary descriptors used concurrently therewith, is as follows.

Random ferns with binary descriptors can be motivated by relaxing the naive bayes conditional independence assumption. When performing naive bayes classification, each feature (in this case, a boolean result of an intensity comparison between two pixels) is assumed to be independent of the values of other features:

p(c|f) ∝Πᵢ p(c|fᵢ). (Equation 1)

In this case, f is a feature vector that corresponds to a binary comparison of intensity image values, p signifies the probability distribution and c refers to a class.

In this case, the conditional independence assumption is strong, and can be relaxed somewhat, taking groups of features as conditionally independent, but fully modeling the interdependence of features within the group. Thus, partitioning the feature vector f into {f¹,f² . . . fⁿ}, with f^{j}={f₁^{j},f₂^{j} . . . fₘ^{j}} a set of binary features, one can model the probability with

p(c|f) ∝Πⱼ p(c|f^{j}), (Equation 2).

In Equation 2, p(c|f^{j}) is directly estimated using the training data (using sample counts to estimate probabilities, as traditionally done in naive bayes classification). Modeling the probability distributions now becomes much harder (which is the reason the conditional independence assumption is so often made); to address this issue, many transformations of the source image are generated, and the probabilities are estimated using all of the transformed images.

This approach has been used with two classes, representing an object and a background class. Keypoints (each keypoint represented by a class) may be matched, which can then be used to estimate a homography to get the 2D area covered by a painting (or other 2D object).

However, in such methods, when extracting a value for each fern, the patch around each keypoint is transformed many times (the type of transformation controlling what variation the keypoint matching would be robust to). For each transformed patch, the fern value is calculated, and added to a histogram. Each histogram contains 2^{numFeatures} bins, corresponding to the possible values of the fern; thus a probability distribution is learned over possible fern values. When matching a detected keypoint, it is possible to use these probabilities to arrive at a better estimate of a matching score. However, this approach requires significant memory: one histogram per fern per keypoint, resulting in a memory use of numKeypoints*numFerns*2^{numFeatures}*sizeof(ushort).

The above can amount to about 6 megabytes per training image, which may not be advantageous for hardware such as an HMD or a mobile phone with strict memory requirements.

Fern Value Derivation

In view of the above, some embodiments, in contrast to some keypoint extractors, a weak keypoint description is utilized. Such a keypoint description does not require significant transformations to an image, but can be reliable and fast in a limited scope of online training-based object detection and pose estimation in the same environment when tracking is lost.

In some embodiments, and as in step 604 in FIG. 6, the methods of utilizing random ferns are extended to learn to recognize a keypoint at or around each of the extracted 2D locations in order to acquire a pose of the object. Such a method or programming instructions may use ferns that are composed of pixel-wise intensity comparisons to learn to recognize such keypoints.

In some embodiments, utilizing the random ferns method to recognize the keypoints may advantageously allow for a reduction in memory for online training, by reducing the number of features per fern but increasing a number of ferns to offset the decrease in total pixel-comparisons. Thus, the instant method may move closer to the naïve bayes perspective and achieve a reduction of memory even in an online training environment.

Further, a descriptor-based method for recognizing keypoints is constructed. In this method, a fern is composed of several ordered features. In some embodiments, a feature may be described by 6 integer values, for example, (xₐ,yₐ,cₐ,x_{b},y_{b},c_{b}), representing the pixel locations and channels for intensity comparison.

The number of integer values that are used is not limited to 6, and may be more or less as appropriate. Further, while an intensity comparison is used herein, comparisons of other characteristics beyond intensity can also be used to derive the fern values.

For the channels, cₐ and c_{b} are assumed to be in the range determined by the number of channels in the image. The image may be a grayscale image, a color image, or channels comprised of some other features obtained through image processing. The pixel locations are in the range determined by the free choice of patch size that will be extracted around each keypoint (so xₐ,yₐ,x_{b},y_{b} can each vary in the range [0,1patchSize−1]). All these values are randomly chosen before any training is done, and remain constant throughout training and detection.

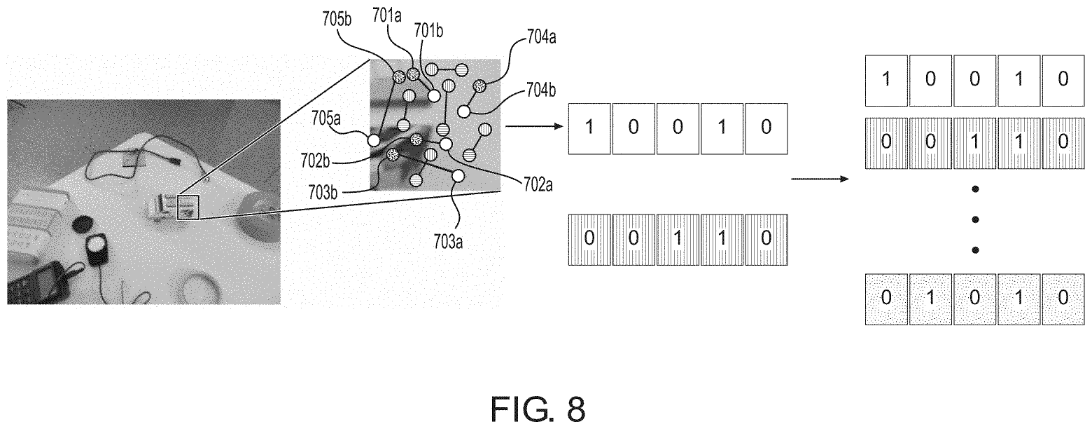

FIG. 7A and FIG. 7B illustrate an exemplary fern on a patch according to some embodiments. A patch may be, for example, a predefined portion of the image (for example, the first image) that is extracted. In FIG. 7A, merely the fern is shown. This exemplary fern includes five features, which correspond to five pairs of pixels, though the number of features is not limited, and may be, for example, 10, or 20, or significantly more. Each of the features is represented by 701, 702, 703, 704, 705, respectively with a two dots 701a and 701b, 702a and 702b, 703a and 703b, 704a and 704b, and 705a and 705b (representing respective ones of the pair of pixels) on either side of the line. The features may be randomly selected.

In developing the binary comparison of the fern, for example, a size or intensity of the pairs of pixels may be compared. In some embodiments, a larger or darker pixel may receive an output of “1,” and a smaller or brighter pixel may receive an output of “0.” The n pixel pairs create a binary vector, which represents a single fern. In embodiments, each training results in an output of one fern, with multiple training iterations used to generate a plurality of ferns.

As described above, the pixels are chosen at random. However, once the pixels are chosen, the order of pixels becomes fixed. For example, an order may be generated as 701a, 701b, 702a, 702b, 703a, 703b, 704a, 704b, 705a, 705b. In such a case, 701a will always be compared with 701b, 702a always compared with 702b, and so on.

The binary output will be established based upon this fixed order and resultant comparison. A value of 1 may be chosen if, for example, 701a is darker or larger than 701b, whereas a value of 0 may be chosen if, for example, 701b is lighter or smaller than 701a. In this embodiment, the darker pixel, if the first of the basis for comparison, results in an output of 1 whereas the lighter pixel, if the first of the basis for comparison, results in the output of 0. However, the comparison may be based upon something other than intensity, such as, for example, edge orientation at each pixel. Further, whether the first or second pixel being darker or brighter (or larger or smaller) need not necessarily result in a particular output value—so long as rules are set for the pixels and the comparison and the subsequent fern is generated in view of such rules, the output can be appropriately generated.

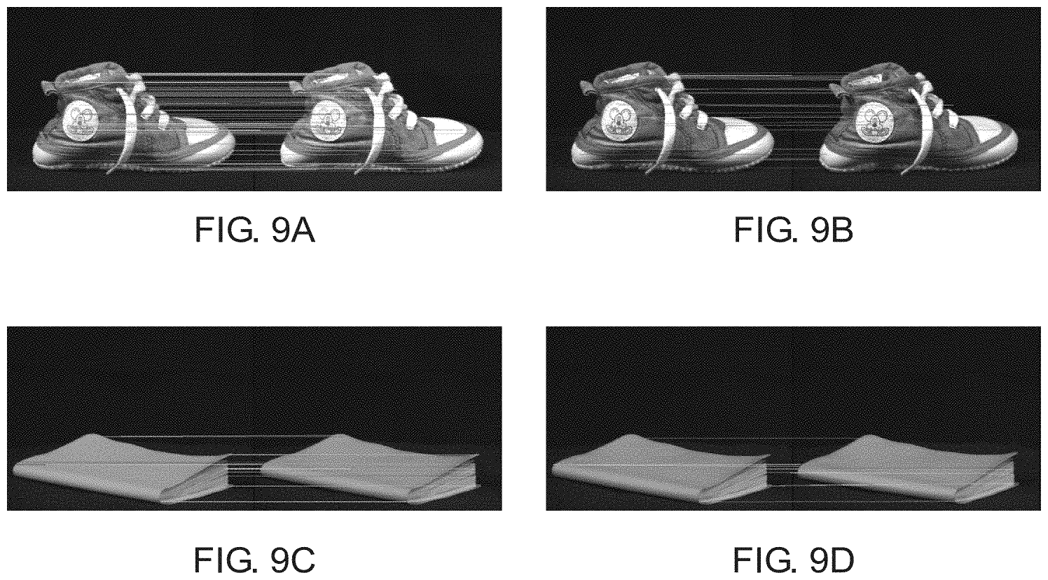

FIG. 8 shows more specific extraction of fern values around a keypoint. In the first diagram of FIG. 8, a set of objects including a target object (in this case, a car) is shown. The highlighted portion of the car is selected as a patch, the patch including a particular keypoint, which may be, for example, a corner of the car. Then, a series of randomly generated pixel sets (each pixel set resulting in a feature) are produced.

In the inset, two trainings are shown to occur within the patch. In some examples, multiple ferns are trained on the same patch, with randomly selected point pairs being selected. A first exemplary fern includes five features, which correspond to 5 pairs of pixels, though the number of features is not limited. Each of the features corresponds to the features of FIG. 7 and thus is represented by 701, 702, 703, 704, 705, respectively with a two dots 701a, 701b, 702a, 702b, 703a, 703b, 704a, 704b, 705a, 705b (representing respective ones of the pair of pixels) on either side of the line. The features may be randomly selected. This corresponds to a first fern.

Also shown in the inset is a series of second features that correspond to a second fern. The features of the second fern are shown without reference numbers. There exist five sets of features, each having a pair of pixels, similar to the first fern.

Next, two vectors corresponding to a fern value at the keypoint for the first fern (top) and a fern value at the keypoint for the second fern (bottom) are shown in FIG. 8. A description of the development of these ferns is described in more detail below.

In the process shown by FIG. 8, a binary descriptor is extracted using two ferns. Given (x,y) coordinates in an image, a patch centered around that point is extracted and a binary descriptor (a binary string) computed for each fern. Per fern, a comparison, which in this example is an intensity comparison, is performed between (xₐ,yₐ,cₐ) and (x_{b},y_{b},c_{b}). These coordinates are relative to an origin at the upper left of the patch.

For a pair of pixels (xₐ,yₐ,cₐ) and (x_{b},y_{b},c_{b}), if Intensity(xₐ,yₐ,cₐ)>Intensity(x_{b},y_{b},c_{b}), then a 1 is added to the growing descriptor, otherwise a 0 is added. After all the feature values have been processed, it produces a bit string of length equal to the number of features per fern, which is 5 in this case, but need not be limited and may be, for example, 10, or 20, or significantly more. The same process is followed for the rest of the ferns, resulting in a vector of bit strings, where the size of the vector is the number of ferns.

As shown in the end of FIG. 8, the two fern value vectors, along with any other fern value vectors taken at the keypoint (not shown), will lead to a combined description, shown at the right side of FIG. 8. In some embodiments, about 25-100, or about 50-75, or about 60 ferns are used to establish one keypoint descriptor. The descriptor may be written as a combination of all of the binary strings established for the keypoint, or as a single array of numbers that takes into consideration all the other binary strings established for the keypoint, or by a single number representing the binary value of such a binary string.

In some embodiments, a patch size of 10×10-30×30 pixels (100-900 total pixels), or about 20 by 20 pixels (400 total pixels), may occur. In a 400 total pixel 20×20 configuration, this would result in 20⁴ or 160,000 possible features.

Extraction of Keypoints and Feature Descriptors and Derivation of Fern Values During Online Training

Using the exemplary fern generation discussed with respect to FIGS. 7 and 8, above, an online training scenario is further described herein.

Given a particular image (e.g., the first image of the image data sequence having its 2D locations of its 2D features extracted as in step 602 of FIG. 6, or the image as described in step 502B of FIG. 5), and a corresponding 3D pose (e.g., a first pose of the object as acquired in step 604 of FIG. 6), a training sequence is performed.

For each training image, which can be done online or offline, but is exemplarily done online, keypoints are extracted, at multiple scales, within a region of interest around the object. Any keypoint detector can be used, provided that it can allow for enough detection points.

In some examples, when training on multiple tracked frames is to occur, ferns trained on a pose can be used to detect an object within 5-7 degrees of pose difference (azimuth or elevation). Thus, if, during testing, an object has a slight pose difference from any training poses (e.g., about 5-7 degrees), the pose can still be detected using ferns that are tolerant to this amount of angular variation. Thus, training may occur with poses that are 5-7 degrees apart from each other. Such information can be acquired during the tracking process. Thus, a new pose would be covered by two neighboring training poses (because the two neighboring poses are 5-7 degrees apart), which can give a scope of detecting the testing image by trained features from at least two neighboring poses, allowing for more robust detection.

In some embodiments, particular objects may require at least 30, or at least 50, keypoints. Further, the keypoints that are extracted for training can also be made more robust to simulated affine transformations.

A keypoint extraction method within the scope of this disclosure includes using a scale pyramid to extract keypoints at multiple scales, and for those extracted at larger scales, the patch size will be increased proportionally to the scale. This larger patch can be scaled down for extraction of fern values.

Once the keypoints or locations of features there at are extracted, the derivation of fern values (or ferns) may occur about such keypoints, as shown in step 603 of FIG. 6.

For each keypoint, a patch is extracted centered on the keypoint, and the fern values are extracted. Before extracting the fern values, the patch can be rotated according to the dominant gradient direction to increase rotational invariance.

Once the fern values are extracted in a manner such as the manner described in the previous section, they are placed, or stored, into a hash table, which will be used for faster keypoint matching. The storage of the fern values may be included in the step 503 of FIG. 5 where a training dataset is stored, or step 605 of FIG. 6 where the fern values around the 2D location and the training dataset, and optionally a corresponding pose, are stored. Steps 605 (as with step 503 in FIG. 5) may be done during online learning or may be performed subsequent to the online learning procedures. For example, step 605 may occur in real time, during the training while tracking described with respect to steps 601-604. In some embodiments, once the fern values are extracted, the storing in step 605 includes placing the fern values into a fast hash table. In some embodiments, each fern is stored in a separate hash table. Such a configuration may allow for faster keypoint matching.

Further, the (x,y) location of the keypoint is back-projected (using the given pose) onto the CAD model to get a 3D point which will be used after keypoints are matched during detection to obtain a 3D pose. Each extracted keypoint thus defines a class, containing a 3D model point and as a vector containing the fern values on the surrounding patch. The same or nearby points on the CAD model may have multiple keypoint classes, each representing its appearance under a different view. For computational reasons, all patch extraction and rotation may be simulated by appropriately modifying the feature offsets, rather than manipulating images directly. After training, added keypoints are compared, and those that are likely to cause confusion, for example those points with small hamming distance, but disparate 3D points, are pruned.

The process described herein differs from other processes using theoretically motivated ferns. Owing at least in part to this system, an online training scenario whereby the surrounding environment for an object to be tracked is unlikely to change significantly during the training regimen can be effectively tracked and a pose estimation (discussed in more detail later) can be generated using an efficient and somewhat simplified model without requiring large memory storage. The system may allow for re-detection even if the object were to move somewhat, as re-detection can start from within a narrow view range.

Further, the division into ferns into fast hash tables, to assist with matching, can achieve particular advantages as compared to more robust, more memory-dependent histograms comparisons. This is advantageous to keep fast detection speeds after training is done over the entire view sphere, as it would otherwise be too slow to search through all training descriptors. Embodiments also include scaling to the descriptor—the scale at which a keypoint was identified in an image is incorporated into the descriptor by adjusting the pixel comparisons to reach proportionally further from the patch center. This application thus applies binary features to enable online training for fast 6-DoF pose estimation (rather than simple keypoint matching) for mobile hardware.

Detection

Detection of a 3D pose (or a “second pose”) on a new image containing the target object is within the scope of this disclosure. Detection may occur in a situation where, for example, the training or tracking has failed and it becomes necessary to re-detect the object by finding a new pose of the object, or it is generally otherwise desired to detect a new pose. In such a case, the method or program may optionally detect a pose lost state of the object pose tracking algorithm (for example, when the pose of the object is lost). To detect a new pose, keypoints are again extracted similarly to in previous embodiments, whereby the search will be extended because the search is now throughout the entire image. That is, the number of extracted keypoints may be significantly above 50, and may be much higher than in the initial keypoint extraction.

For each detected keypoint, a surrounding patch is extracted and fern values are calculated similar to the method described with respect to FIGS. 7 and 8 and within step 603 of FIG. 6.

Next, the method or program will perform a search for matching keypoints. For each fern, the value on the detected patch is used to search the hash table corresponding to that fern. If an exact match is found, the corresponding training keypoint class is saved in a memory, such as the ROM 121.

Once all the classes have been found, the method or program may include iterations through each of the classes, and the training class that has the most exact fern-value matches is determined to be a match. That is, matching occurs when the value of one fern for a keypoint matches with the value of another fern. In a situation where less than a predetermined number of matches are reached, the method or program may determine no matches.

In some embodiments, a matching score to a training keypoint was considered to be increased depending on the hamming distance between the descriptors.

Once matches have been found for a predetermined number of keypoints, the method may run a pose estimation algorithm to find a full 3D pose. In some embodiments, RANSAC PNP, which may be robust to outliers, and can thus withstand the noisy matches from the ferns, is used. For example, the methods and program operation may, for each keypoint, extract the fern values, find a best match among training descriptors if available, add a match to 2D-3D correspondences, and run a system, such as RANSAC PNP, to acquire the 3D pose.

In some embodiments, the trained random ferns work similar to a feature detector to detect and store keypoints represented by the ferns as well as their corresponding 3D coordinates from the learnt pose using the 3D CAD model. Hence, when extracted keypoints from a query image are matched to some stored keypoint ferns learnt from already trained views, the correspondences between the 2D keypoints and their 3D coordinate counterparts, RANSAN PnP can derive a rough 3D pose. That is, the method and program may derive a 3D location for each of the 2D locations by projecting the 2D locations back into a three-dimensional space using a 3D pose and a 3D model corresponding to the object, and subsequently store the full 3D pose.

Advantages

The methods and program operation described in the preceding paragraphs allows for binary features with random ferns to be extended to full 3D pose estimation. The method and program operation may work for training with multiple images.

Further, the methods and program allow for learning a 3D pose in an online manner, given that training can take a significantly less time as compared to other methods known in the art. For example, training may take around only 200 ms, the time remaining constant regardless of how much previous training has occurred. Further, a use of output of a tracking module as the ground truth training pose can be used for online learning, and the subsequent memory reductions established by this method can allow for the user of sufficient training images to cover a full view-sphere without exceeding a desirable memory capacity.

Further, using a patch size as described above (20 by 20 pixels), parameters requiring only 60 ferns and 10 features each, which amount to less than one half of one percent of the possible features in the patch, can achieve a desirable performance.

The present application may further allow for application of a gradient-based orientation to increase rotational invariance as done in ORB and SURF keypoint descriptor analysis, in addition to scaling the patch size according to the scale at which the keypoint was extracted to achieve scale invariance. The improved rotational and scale invariance of the entire pipeline due to these changes have been achieved by methods of the above-described embodiments.

Further, the present application allows for a fast method for finding matches. After training on several images that are necessary to cover a full view sphere, each with many keypoints, iterating through all training keypoints would become expensive and slow. Instead, the improved use of hash tables, each corresponding to a fern, which maps from binary strings to training keypoint classes is achieved by the methods and programming described above.

For example, when the fern values for a detected keypoint have been calculated, each hash table is searched for matching values, and the training keypoint class with matches across the greatest number of ferns is considered a match. While detection time of course slows as more training data is added, this method greatly reduces the number of classes that need to be search, is guaranteed to find training matches, and reduces the processing time greatly over that in the cited art.

Evaluation

Evaluations to show operations and results of the methods and programming of this disclosure were performed, and are provided herein. Generally speaking, the methods described above and evaluated herein involve receiving an input tracker pose during a training process, performing some type of pre-processing, which may include an edge alignment score or otherwise acquiring keypoints and/or 2D features, training by acquiring the ferns at each keypoint, and outputting trained views. Further, during a detection phase, a raw image may be input or a pose lost state may be input, detection of keypoints or 2D features and ferns at such keypoints or 2D features may be acquired, an edge alignment score or some other quantitative metric can be determined, and a detected pose may be output.

To evaluate the method, sequences with dynamic and continuous views of a target, with an associated CAD model, and ground truth poses for every frame are needed. Such sequences are defined in, for example, (1) Bhoram Lee and Daniel D. Lee, “Online learning of visibility and appearance for object pose estimation,”IEEE/RSJ Inter-national Conference on Intelligent Robots and Systems (IROS),2016, and (2) Bhoram Lee and Daniel D. Lee, “Self-supervised online learning of appearance for 3d tracking,”IEEE/RSJ International Conference on Intelligent Robots and Systems (IROS), 2017, each of which is incorporated by reference herein.

The Big Bird dataset, for example as defined in Karthik Narayan Tudor Achim Pieter Abbeel Arjun Singh, James Sha, “Bigbird dataset,” available at http://rll.berkeley.edu/bigbird/ on May 26, 2020, incorporated by reference herein, has images every 5 degrees, while the datasets used in (1) and (2) above with moving objects also do not have continuous frames (the drill sequence, for example, has images every 6 degrees while it is being rotated). While results are qualitatively decent on these datasets, they require training almost every frame, as our angular coverage cannot cover this distance accurately, as discussed below.

The exemplary evaluation is done on several in-house datasets. Collected with an OptiTrack system as described in “Optitrack,” available at https://optitrack.com/ as of May 26, 2020, incorporated by reference herein, these sequences have very high quality ground truth poses, full 360 degree coverage, and very dense views. Thus, the primary evaluation is done on several in-house datasets. Collected with the OptiTrack system, these sequences have very high quality ground truth poses, full 360 degree coverage, and very dense views.

For evaluation metrics, a difference between poses was divided into rotational and mask-overlap components. Representing the poses as two 4×4 matrices, P_{A} and P_{B}, rotation error is defined as the angle between the rotation components of those matrices. Defining R=R_{A}^{T}R_{B} as the B rotation followed by undoing the A rotation (R_{A}^{T}=R_{A}⁻¹), the rotation error is defined as

$$θ = arccos ( \frac{T r ( R ) - 1}{2} ) ,$$

i.e. the angle from the angle-axis representation of R.

Further, the 2D intersection over union (overlap) of the objects masks was used, with a threshold for calculating a correct detection rate (CDR) (see Table 4 below).

It was determined to be possible to evaluate both while learning online, and with learning offline by sampling the view sphere with ground truth poses. In addition, the training ground truth poses can either be the correct ground truth, or the output from a separate tracker, which is separately capable of initially detecting and then tracking the 3D pose of the object.

To obtain cleaner results training is done using the correct ground truth poses; tests with a tracker show similar results, but a wrong pose is occasionally learned when the tracker fails.

Evaluation results for keypoint matching (absent any pose estimation) are shown. Later, a variety of pose estimation results are described: (a) the improvement resulting from using rotation-invariant features, (b) results using full histograms rather than our new feature-based method, (c) timing results for both training and detection, and (d) final results on long and dense sequences.

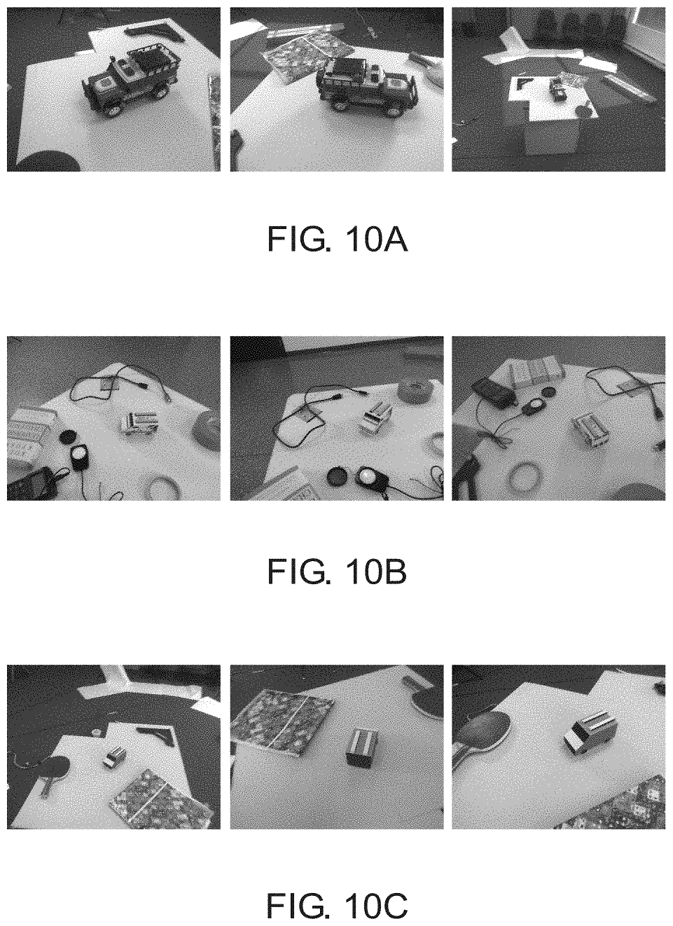

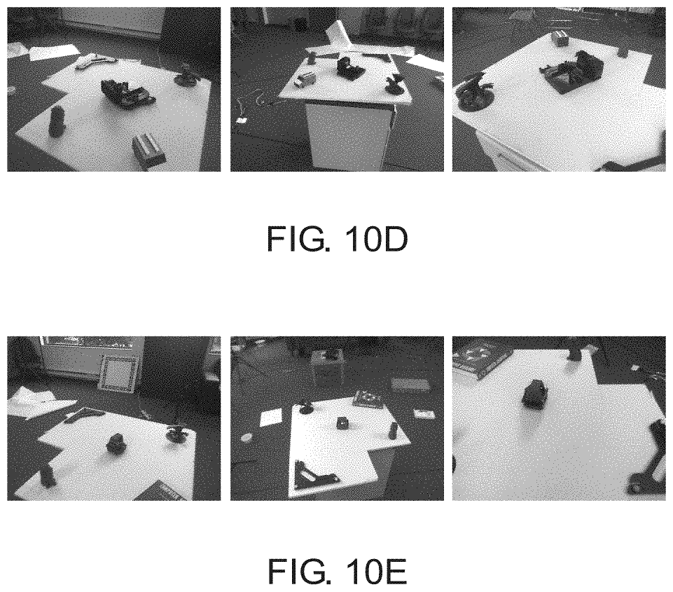

First, some results of pure keypoint matching are shown. FIGS. 9A-9D show qualitative results from matching on both a relatively rich feature shoe (for example, ALOI sequence 9 as described in https://aloi.science.uva.nl/, incorporated by reference herein) and low feature book (ALOI sequence 214). Matching is shown to be good even in the presence of clutter, as shown in video sequences represented in FIGS. 10A-10E, defined in more detail below. The matching scores (ratio of correct matches to number of detected keypoints) for several objects are shown in Table 1. FIG. 9A shows a first item (a shoe) during an illumination change, while FIG. 9B shows the show during a 10 degree rotation. Similarly, FIG. 9C shows a book having an illumination change, while FIG. 9D shows the book at 5 degrees of rotation.

Because ground truth transformations are not available for this dataset, a distance between pixel coordinates was used as a heuristic for determining correct matches.

For keypoint matching 32 ferns of 8 features were used for easy comparison to other methods, such as BRIEF. As shown in Table 1, the feature matching performance of random ferns is comparable to both BRIEF and ORB. The ferns offer a few other advantages in the context of online learning for pose estimation. For example, they are fast to extract during training and detection (faster than the openCV implementations of BRIEF and ORB), and the detection accuracy can be easily traded for reduced detection time with customization of the number of ferns and features.

TABLE 1
Matching score on sequences from the ALOI dataset. All tests were done
with two different illuminations and under both 5 and 10 degree rotations.

| Object | BRIEF | ORB | Ferns |
|---|---|---|---|
| 6 | 0.88 | 0.88 | 0.87 |
| 9 | 0.84 | 0.79 | 0.71 |
| 18 | 0.90 | 0.87 | 0.84 |
| 21 | 0.82 | 0.77 | 0.83 |
| 32 | 0.79 | 0.72 | 0.74 |
| 125 | 0.79 | 0.76 | 0.74 |
| 214 | 0.78 | 0.80 | 0.84 |
| 217 | 0.91 | 0.86 | 0.85 |
| 233 | 0.94 | 0.89 | 0.82 |

To test rotation invariance, we compared correct detection rate (CDR) with and without gradient based rotation of patches. Training is run on one image, and then detection is run on that image rotated (in plane) in increments of 3 degrees. This procedure is run for multiple objects, each tested at multiple views. The results shown in Table 2 show clearly the improvement to rotation invariance.

TABLE 2
Results before and after adding rotation invariance.

| Object | Raw CDR | Improved |
|---|---|---|
| SUV | 0.125 | 0.86 |
| Rich Feature Papercar | 0.10 | 0.81 |
| Low Feature Papercar | 0.14 | 0.74 |
| Fanspart | 0.06 | 0.32 |
| Lamppart | 0.01 | 0.12 |

Next, results using the original ferns with full histograms are shown. These histograms correspond to a comparative example.

TABLE 3
Results using full histograms with training done every 7 degrees.

| Object | Length | CDR |
|---|---|---|
| SUV | 2519 | 0.95 |
| Rich Feature Papercar | 1681 | 0.96 |
| Low Feature Papercar | 2341 | 0.94 |
| Fanspart | 1720 | 0.81 |
| Lamppart | 1461 | 0.26 |

Keeping the total number of pixel comparisons constant, embodiments of the improved training and hash table-based searching (table 5) are compared to those results in the table 3 above. We are able to almost match these results while reducing memory consumption by almost 3 order of magnitude, reducing the average training time by about 100 ms, and detection time by more than a full second (see [0154]). Sample images from the sequences are shown in FIG. 10. FIG. 10A shows an SUV at various positions, FIG. 10B shows a rich feature papercar at various positions, FIG. 10C shows a low feature papercar at various positions, FIG. 10D shows an item, heretofor called a fanspart, at various positions. FIG. 10E shows an item, heretofor called a lamppart, at various positions.

For the main evaluation, we show results for several objects shown in Table 5. Training occurred every 7 degrees in azimuth or elevation, as well as when there is a >30 cm change in viewing distance. Denser training slows down the module and only slightly improves results, but results begin to suffer more significantly with less dense training.

All the parameters (number of ferns, features, patch size, etc.) are as above, summarized in Table 4. All training and testing may be done on grayscale images, as is shown in the instant example. A correct detection is a detected pose within the rotation and 2D overlap thresholds.

TABLE 4
Parameters of the ferns and thresholds used in evaluation.

| Parameter | Value |
|---|---|
| Number of Ferns | 60 |
| Features per Fern | 10 |
| Patch Size | 20 by 20 |
| Training keypoints per image | 80 |
| Detection keypoints per image | 300 |
| Rotation Threshold | 10 degrees |
| Overlap Threshold | 0.80 |

TABLE 5
Evaluation results on full sequences, with training done every 7 degrees.

| Object | Length | # Training Images | CDR |
|---|---|---|---|
| SUV | 2519 | 145 | 0.97 |
| Rich Feature Papercar | 1681 | 133 | 0.97 |
| Low Feature Papercar | 2341 | 106 | 0.88 |
| Fanspart | 1720 | 137 | 0.74 |
| Lamppart | 1461 | 99 | 0.11 |

The system, methods and programming of this application allow for a reduction of computational demands of the algorithm for use with online learning and on mobile devices. Thus, the system was tested on both a PC (Intel Xeon 3.1 GHz processor, 4 cores, 8 GB RAM) as well as Pixel 2 (Qualcomm Snapdragon 1.9 GHz processor, 8 cores, 4 GB RAM). Table shows averaged timing results Eliminating the pruning of the training data somewhat reduces training time at the cost of increased detection time.

TABLE 6
Timing results (s) on a PC and Pixel 2.

| | PC | Pixel 2 |
|---|---|---|
| Training Time | 0.205 | 0.641 |
| Detection Time | 0.059 | 0.127 |

Finally, a training density comparison was performed. The results of the system and method above apply when training every 7 degrees. These results may vary as this training density is modified. At one extreme, very high training density gives the best accuracy, but it may not be possible to train in real-time, and detection may also get slow (up to 1 s by the end of a sequence) due to the larger number of training keypoints that are potential matches. At the opposite end, however, training views are too sparse to sufficiently cover the view sphere.

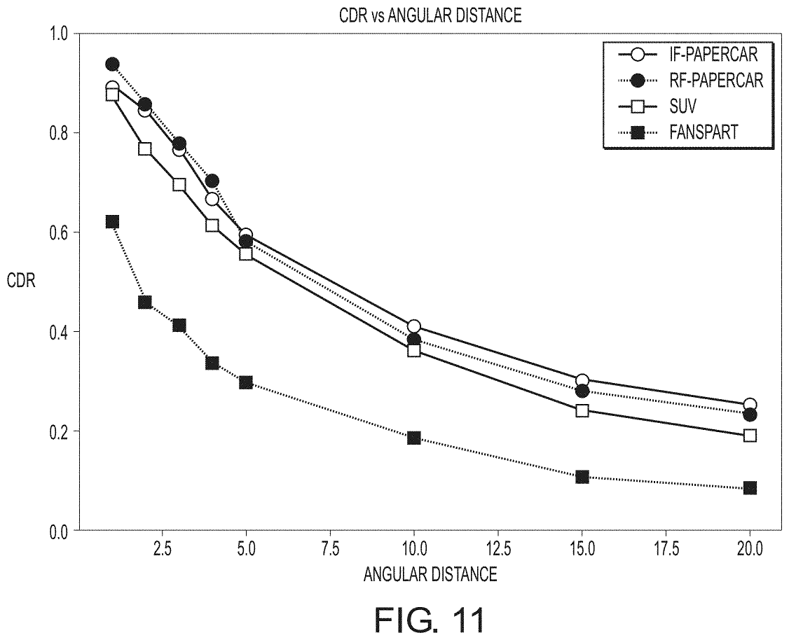

A determination was made of how far (in degrees) it is possible to detect from a given training image. For each sequence, every n^{th} frame is selected to train, and then tested on every image within a given angular range. Results are shown in FIG. 11.

As will be appreciated by one skilled in the art, aspects of the present invention may be embodied as a system, method or computer program product. Accordingly, aspects of the present application may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a non-transitory computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the non-transitory computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a non-transitory computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a non-transitory computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and block diagrams of methods, apparatuses (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “has,” “have,” “having,” “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The explicit description of the present invention has been presented for purposes of illustration and description, but is not intended to be exhaustive or limited to embodiments of the invention in the form explicitly disclosed. Many modifications and variations will be apparent to those of ordinary skill in the art without departing from the scope and spirit of embodiments of the invention. The embodiment was chosen and described in order to best explain the principles of embodiments of the invention and the practical application, and to enable others of ordinary skill in the art to understand embodiments of the invention for various embodiments with various modifications as are suited to the particular use contemplated.

Although specific embodiments have been illustrated and described herein, those of ordinary skill in the art appreciate that any arrangement which is calculated to achieve the same purpose may be substituted for the specific embodiments shown and that embodiments of the invention have other applications in other environments. This application is intended to cover any adaptations or variations of the presently described embodiments. The following claims are in no way intended to limit the scope of embodiments to the specific embodiments described herein.

What is claimed is:

1. A non-transitory computer readable medium storing instructions to cause one or more processors to:
acquire, from a camera or one or more memory storing an image data sequence captured by the camera, the image data sequence containing images of an object in a scene along a time;
track a pose of the object through an object pose tracking algorithm;
during the tracking of the pose of the object, acquire a first pose of the object in an image of the image data sequence;
during the tracking of the pose of the object, extract 2D features of the object from the image; and
store a training dataset containing the extracted 2D features and the corresponding first pose in the one or more memories or other one or more memories.

2. The non-transitory computer readable medium according to claim 1, wherein the storing of the training dataset occurs during the tracking of the pose of the object.

3. The non-transitory computer readable medium according to claim 1, wherein the tracking of the pose is performed in an online learning environment.

4. A non-transitory computer readable medium storing instruction to cause one or more processors to:
acquire, from a camera or one or more memories storing an image data sequence captured by the camera, the image data sequence containing images of an object in a scene along a time;
extract 2D locations of 2D features on a first image in the image data sequence;
derive fern values around each of the extracted 2D locations;
acquire a first pose of the object in the first image with respect to the camera; and
store, in the one or more memories or other one or more memories, a training dataset containing each of the 2D locations, the fern values around each of the 2D locations, and the corresponding pose.

5. The non-transitory computer readable medium according to claim 4, wherein the instructions further cause the one or more processors to:
derive a 3D location for each of the 2D locations by projecting the 2D locations back into a three-dimensional space using a 3D pose and a 3D model corresponding to the object; and
store, in the one or more memories or the other one or more memories, the training dataset containing each of the 2D locations, the fern values around each of the 2D locations, the 3D location of the corresponding 2D location, and the corresponding pose.

6. The non-transitory computer readable medium according to claim 5, wherein the corresponding pose is a 3D pose that is generated taking into consideration a number of matching ferns at the corresponding 2D location.

7. The non-transitory computer readable medium according to claim 4, wherein the instructions further cause the one or more processors to:
determine a pose lost state of the object pose tracking algorithm; and
derive a second pose of the object using a second image of the image data sequence and the training dataset stored in the one or more memories when the pose lost state is determined.

8. The non-transitory computer readable medium according to claim 4, wherein the image is a 2.5 dimensional image or a 2.5 dimensional video sequence of the object.

9. The non-transitory computer readable medium according to claim 4, wherein, a keypoint is extracted at at least one extracted 2D location.

10. The non-transitory computer readable medium according to claim 9, further comprising determining a patch around the keypoint.

11. The non-transitory computer readable medium according to claim 10, wherein the patch includes about 100-900 pixels.

12. The non-transitory computer readable medium according to claim 4, wherein each of the 2D locations includes a plurality of pairs of pixels.

13. The non-transitory computer readable medium according to claim 12, wherein the deriving of the fern values includes deriving about 25-100 ferns at using a combination of ones of the plurality of pairs of pixels.

14. The non-transitory computer readable medium according to claim 4, wherein the training dataset is stored in a hash table.

15. The non-transitory computer readable medium according to claim 14, wherein each of the fern values is stored in a separate hash table.

16. The non-transitory computer readable medium according to claim 15, wherein for each fern, the fern value is used to search the hash table corresponding to that fern, and a match is stored in the one or more memories.

17. The non-transitory computer readable medium according to claim 4, wherein the extracting 2D locations of the 2D features, the deriving of the fern values around each of the extracted 2D locations, and the acquiring a first pose of the object in the first image with respect to the camera occurs during an online learning environment.

18. A method comprising:
acquiring, from a camera or at least one memory storing an image data sequence captured by the camera, the image data sequence containing images of an object in a scene along a time;
extracting 2D locations of 2D features on a first image in the image data sequence;
deriving fern values around each of the 2D locations;
acquiring a first pose of the object in the first image with respect to the camera; and
storing, in the at least one memory or another memory, a training dataset containing each of the 2D location, the fern values around each of the 2D locations, and the corresponding pose.

19. The method according to claim 18, further comprising:
deriving a 3D location for each of the 2D locations by projecting the 2D locations back into a three-dimensional space using a 3D pose and a 3D model corresponding to the object; and
storing, in the at least one memory or the another memory, the training dataset containing each of the 2D locations, the fern values around each of the 2D locations, the 3D location of the corresponding 2D location, and the corresponding pose.

20. The method according to claim 18, further comprising:
determining a pose lost state of the object pose tracking algorithm; and
deriving a second pose of the object using a second image of the image data sequence and the training dataset stored in the one or more memories when the pose lost state is determined.
